(19) United States
(12) Patent Application Publication
(10) Pub. No.: US 2010/0043129 A1
(43) Pub. Date: Feb. 25, 2010

(54) METHOD AND CONTROL SYSTEM FOR PROCESSING GREYWATER

(76) Inventors: Johannes Donaes Jacobus Platteel, Muiden (NL); Sjoerd Pieter Wouda, Muiderberg (NL)

Correspondence Address: THE NATH LAW GROUP, 112 South West Street, Alexandria, VA, 22314, US

(21) Appl. No.: 12/526,749

(22) PCT Filed: Feb. 6, 2008
(86) PCT No.: PCT/NL08/00035

§ 371 Date: Oct. 8, 2009

(30) Foreign Application Priority Data
Feb. 12, 2007 (NL) 1033373

(51) Int. Cl. E03D 3/00; E03B 1/04; C02F 1/00; C02F 1/68; E03C 1/00

(52) U.S. Cl. 4/300; 210/739; 210/746; 210/743; 210/742; 210/744; 210/96.1; 137/1

(57) ABSTRACT

The present invention relates to a method for processing greywater, comprising the following steps:—supplying water to a reservoir of a greywater device;—collecting the supplied water in the reservoir;—conducting water out of the reservoir to at least one reservoir of a water consumer;—monitoring the water quality; and—flushing the water from the reservoir of the greywater device and/or the reservoir of the water consumer into a sewer drain when the water quality drops below an acceptable level. Furthermore, the invention relates to a control system for controlling a greywater device, a system for reusing greywater, comprising a greywater device and a control system, and a greywater consumer, in particular a toilet, which is connected to such a system.

The present invention relates to a method for processing greywater, a control system for controlling a greywater device, a system for reusing greywater and a greywater consumer connected to such a system.

A method of economically managing energy in the environment is to reuse slightly contaminated water. Instead of tap water, that is purified with much effort and expenses in sewer water purification installations, less pure non-drinkable water can also be used for some uses such as, e.g., flushing a toilet. Thus, it is possible to conceive of using collected rainwater and reusing slightly contaminated bath and shower water as well as water used by washbasins and washing machines. Such slightly contaminated water is also called greywater. In addition, the saving of water as a consequence of the reuse of water also brings about a reduction of the load on the sewer.

Dutch patent NL-1011371 of the applicant describes a reservoir for greywater with a supply of greywater and a drain connected to a greywater consumer such as a toilet or the like. The reservoir is provided with an outlet that communicates with the sewerage and is provided with a closing device to be opened by a timer at controlled times. The attempt is made to limit the development of undesired odors that result in a odor nuisance by regularly flushing greywater.

A disadvantage of the device described in the above-mentioned Dutch patent is that the flushing of the reservoir based purely on time proved to be unsuitable in practice for handling the great variety of situations that occur in practical applications and for preventing odor development in these diverse situations.

An object of the present invention is to improve the method for the processing of greywater of the type cited in the introduction and in particular to create a method suitable for preventing undesired odor development in practical applications.

This object is achieved with the method for processing greywater in accordance with the present invention, comprising the steps of:
supplying water to a reservoir of a greywater device;
collecting the supplied water in the reservoir;
conducting water out of the reservoir to at least one reservoir of a water consumer;
monitoring the water quality; and
flushing the water from the reservoir of the greywater device and/or from the reservoir of the water consumer into a sewer drain when the water quality drops below an acceptable level.

As a result of the fact that in the method in accordance with the present invention the water quality is determined and a determination is made therewith in an interactive manner whether the water located in the reservoir of the greywater device and/or the reservoir for water consumption should be flushed to a sewer drain, a method is created that—in contrast to time-switched methods—is capable of handling in a flexible manner the diverse situations that occur in practical applications.

Flushing the reservoir of the greywater device, as well as the reservoir of the water consumer, e.g. the flushing tank of a toilet, in accordance with the method of the present invention prevents a long standstill of greywater that results in odor nuisance even in the water consumer. Especially when the water consumers are located in a relatively warm environment such as, e.g., in a shower room, the bacteria present in the greywater are capable of more rapidly developing a culture and/or fauna in the flushing tank. By also controlled flushing the flushing tank of the toilet that comprises greywater supplied from the greywater reservoir, odor nuisance is prevented in the room where it is most rapidly experienced by a user.

In a preferred embodiment of the invention the step of monitoring the water quality comprises frequently and satisfactorily determining at least one of the properties or parameters determining the water quality. Based on perceived and expected changes in the water quality, the system reacts by flushing water out of the collecting reservoir and/or out of the reservoir of the water consumer to a sewer drain when the water quality drops below an acceptable level. In fact, the water in the greywater system is kept young. The present invention is based on the principle of ‘keep the water young’. As a result of the fact that the water quality is estimated, determined or measured satisfactorily frequently, the method is capable of perceiving changing circumstances and reacting to them interactively. It is clear to a person skilled in the art that when using the present invention the wording “satisfactorily frequently” comprises a continuous (analog) as well as a periodic sampling (digital) with a satisfactorily high sampling frequency such as, e.g., on the order of 1 Hz.

In a preferred embodiment of the invention it furthermore comprises the steps of:
assigning a water quality value to the collected water; and
adapting the water quality value as a function of at least one parameter that influences the water quality.
   The collected greywater is assigned a water quality value, that is dependent on factors such as the source (e.g. shower), and the amount of supplied greywater from this source (short or long period of using the shower), since the latter is an indication of the expected concentration of contamination in the greywater. The water quality value is adapted interactively as a function of at least one parameter that influences the water quality. Based on this interactively adapted water quality value, the system flushes the water from a reservoir of the greywater device and/or from the reservoir of a water consumer (e.g. a toilet) into a sewer drain when the water drops below an acceptable level. By emptying the reservoirs on basis of the interactively adapted water quality value, ‘the water is kept young’, and development of culture and/or fauna in the reservoirs is prevented. Therefore, also odor nuisance is prevented.

In a further preferred embodiment the method furthermore comprises the step of adapting the water quality as a function of at least one of the parameters:
temperature of the supplied water;
temperature of an environment of the collecting reservoir of the greywater device;
temperature of an environment of the reservoir of the water consumer;
origin of the supplied water;
contaminants present in the water;
additives present in the water;
the amount of the supplied water; and
in which reservoir the water is located;

Since bacteria develop better in a warm environment, the temperature of the supplied water—which varies, e.g., when someone takes a cold or warm shower—will influence the bacterial growth to be expected. In addition, the temperature of the environment of the collecting reservoirs in which greywater is collected as well as of the greywater device and of the water consumer influence the development of bacterial growth in the reservoirs concerned. Furthermore, the amount of supplied water—which fluctuates with the duration of taking a shower—influences the concentration of the contaminants present in the supplied water. By including these and other, above-cited parameters in the determination of the water quality the method of the invention is capable of reacting flexibly to diverse practical situations.

In a further preferred embodiment of the invention the origin of the supplied water is at least one of the sources: shower, bath, dish-washer, washing machine or rainwater. Since each of these sources comprises characteristic contaminants, the water quality to be expected can be determined using the source of origin and an appropriate processing is adjusted. For example, soap remnants are present in shower- and bathwater that float on the water surface and hair and flakes of skin are present that sink when they have a higher density than water. The presence of soap remnants will impart a somewhat basic acidity to shower- and bathwater, while that is not to be expected in water coming from rainwater. In addition, in water coming from washbasin water the presence of contaminants in the form of fats and food remnants is to be expected.

In a further preferred embodiment the method furthermore comprises the step of detecting contaminants present in the water by at least one of:
measuring an electrical conductivity of the water;
measuring the concentration of hydrocarbons;
measuring the concentration of oxygen;
measuring the concentration of urea;
measuring the concentration of coliform elements;
measuring the iron content in the water;
measuring the acidity of the water;
measuring with the aid of biosensors; and
measuring the presence of byproducts produced as a consequence of contaminants.

It turned out in practice that the presence of hydrocarbons in the water, e.g., as a consequence of washing body parts contaminated with gasoline or diesel fuel, in the greywater system results in a great chance of odor nuisance. Even the concentration of oxygen turned out to be a significant indicator when determining the development of anaerobic bacteria that proved to be especially responsible for the occurrence of an undesired odor development. The presence of urine and feces can be detected by respectively measuring the concentration of urea and the concentration of coliform elements. In particular, when children make use of a shower and babies are rinsed off, these elements, that have a very disadvantageous influence on the quality of the greywater, can end up in the water. Furthermore, the presence of blood can be detected by measuring the iron content in the water. In addition, the acidity of the water is determined with a so-called pH measuring and other contaminants present in the water can be detected with the aid of biosensors. The measuring of the presence of byproducts that are produced as a consequence of contaminants, e.g., the measuring of nitrite that is converted by some bacteria from nitrate, can indicate the presence of these bacteria.

In a further preferred embodiment the method furthermore comprises the step of actively adding a purification additive as a function of the water quality, which influences the water quality. Although it is preferable to add the purification additive in an active manner as a function of the water quality it is clear that a passive adding of purification additive is also possible for influencing the water quality. In addition, other possibilities for combating bacteria are possible such as, e.g., the use of a source of UV light.

In a further preferred embodiment the additives present in the water are determined, which additives comprise, e.g., purification additives such as disinfectants. The water quality can be influenced by adding a purification additive, especially chlorine. It is likewise conceivable that other additives such as colorants or deodorants are added to the water. In some countries, e.g., Spain, the adding of colorant is obligatory in order to distinguish greywater from tap water in a visible manner.

In a further preferred embodiment the acceptable level of the water quality that serves as the lower limit for determining whether water should be flushed into the sewer drain is a function of the type of reservoir in which the water is located, as a result of which, depending of the type of reservoir, the location of the latter, and the sensitivity for the development of a odor nuisance for the reservoir in question, the system makes optimal use of the greywater present. It prevents that a culture and/or fauna develops in the greywater device. A poorer water quality is allowed in the reservoir of a water consumer, usually a toilet flushing tank; however, it should also be flushed before a development of odor occurs in it.

In a further preferred embodiment the method furthermore comprises the step of determining with a sensor the amount of supplied water, the sensor monitoring at least one of the following parameters: water level, amount of flowthrough, overflow of water into the reservoir of the greywater device, and flowthrough of water into a bypass conduit of the greywater device. By determining the amount of the supplied water, the concentration of contaminants present in the supplied water to be expected can be estimated at the same time. In an especially advantageous embodiment the origin of the water is also considered here. When the system is filled with tap water the concentration of greywater is diluted, which improves the water quality.

In a further preferred embodiment the method furthermore comprises the step of flushing the water collected in the collecting reservoir when the amount of the supplied water remains below a determined threshold value. It is prevented in this manner that water with a too concentrated amount of contaminants is collected in the reservoir.

In a further preferred embodiment the method furthermore comprises the step of preventing the flushing of the water in the reservoir of the greywater device when water is used by a water consumer before the passage of the time period.

It is prevented in yet a further preferred embodiment that water is unnecessarily flushed by preventing the flushing of the water in the collecting reservoir of the greywater when water is consumed by a water consumer before the passage of the time period. When greywater with a high concentration of contaminants is used in the short term, no odor development will occur after all, since this only occurs during a longer standstill.

According to a further preferred embodiment of the method, a supply of water in an amount less than a predetermined value is ignored as a supply of water. This prevents a brief inflow of shower water, e.g., by someone rinsing something under the shower, from being viewed as a brief use of a shower with a heightened risk of a high concentration of contaminants. Thus, is it prevented that the system flushes greywater unnecessarily. In addition, the system becomes insensitive by this measure to error messages as a consequence of a leaky faucet or an otherwise unintended very slight supply of water.

The present invention furthermore relates to a method comprising the steps of:
measuring the time interval between successive supplies of water to the collecting reservoir of the greywater device;
defining successive supplies as one single supply of water when they occur within a predetermined time interval; and
defining subsequent supplies as a separate first and following supply when they occur outside of a predetermined time interval, and further comprising the step of flushing the water of the first supply out of the collecting reservoir and filling the collecting reservoir with the water from the following supply.

As a result of defining two successive supplies of water within a time period of a predetermined value, typically several hours, e.g., 3 hours, as a single supply, the reservoir of the greywater device is filled without a flush taking place in the interim. However, when the time period between the two successive supplies is greater than the previously defined time period, the “old” water present in the reservoir is flushed and the reservoir is filled with the “new” supplied greywater as result of which the water is kept young, thereby applying the ‘keep the water young’ principle according to the present invention.

In a further preferred embodiment the method furthermore comprises the step of keeping track of the number of refill times since the flushing to the sewer drain, and the flushing of the water collected in the reservoir when a predetermined number of refill times is reached since the last flush. As an alternative or as a supplementation, the method comprises the step of keeping track of the time interval since a flush to the sewer drain, and comprises the flushing of the water collected in the collecting reservoir when a predetermined time interval since the last flush has lapsed. The collecting reservoir of the greywater device is periodically flushed as a function of (a combination of) above criteria, as result of which the water present in the collecting reservoir is discharged to the sewer drain and at the same time contaminations accumulated in the collecting reservoir are also discharged to the sewerage.

According to a further preferred embodiment, filling the reservoir with tap water after flushing it, provides the reservoir periodically with clean tap water, which reduces the possible development of bacteria and the associated development of odor. The reservoir is preferably filled only partially with such an amount of tap water that at least sufficient water is present for making one to two flushes of the reservoir of the water consumer. In this manner the system remains continuously available while the consumption of tap water is limited.

In a further preferred embodiment a purification unit is attached in the reservoir that puts water under high pressure against the inner walls of the reservoir and in this manner removes bacterial growth formed on the walls and removes it to the sewer drain.

Flushing the reservoir filled with tap water a predetermined maximal number of times in a further preferred embodiment to the sewer drain prevents that in the case of a rather long standstill of the greywater device the latter is not flushed repeatedly and is filled with tap water. Such a situation can occur, e.g., during a rather long absence due to a vacation of the user. After a previously determined maximal number of refills, e.g., after two times, the water present in the reservoir is assumed to be clean, after which no further flushing is necessary.

The present invention furthermore relates to a control system for controlling a greywater device, comprising:
at least one sensor connected to the control system, for measuring a water quality of water collected in a reservoir of the greywater device and/or collected in a reservoir of a water consumer connected to the greywater device; and
flushing the water out of the reservoir of the greywater device and/or out of the reservoir of the water consumer connected to the greywater device, when the water quality drops below an acceptable level as a function of the measured water quality.

The present invention furthermore relates to a system for reusing greywater comprising a greywater device and a control system, said greywater device comprising:
a water supply for supplying greywater;
a collecting reservoir for collecting the supplied greywater;
a conduit connected to a water consumer;
a sewer drain and a control system such as described above.

The present invention furthermore relates to a greywater consumer, in particular a toilet, that is controlled by a control system such as described above.

An exemplary embodiment is further elucidated in the following description using the drawing, in which the figure is a schematic reproduction of a greywater device with a control system for the processing of greywater in accordance with the present invention.

The preferred embodiment as shown in the figure comprises a greywater device 1 with a collecting reservoir 2, a storage tank 4, an overflow 6 with a removal instrument (skimmer) 8, a bypass conduit 10, a siphon pipe 12 that connects collecting reservoir 2 and storage tank 4, a supply conduit 14 for supplying greywater, and a discharge conduit 16 for discharging water to a flush tank 20 of water consumer 18 such as a cistern of a toilet that also comprises a sewer drain 22. Greywater device 1 furthermore comprises a sewer drain 24, and air vents 26, 28 are attached on the top in collecting reservoir 2 and storage tank 4. When the water in collecting reservoir 2 reaches a determined level (as shown in the figure), this water is removed via skimmer 8, overflow 6 and bypass conduit 10 to sewer drain 24. In the embodiment shown, a sensor 30 is attached in the bypass conduit which communicates via wiring 32 with a control system 34 (Ecoplay Control Unit: ECU). This control system is connected via wiring 36 to an actuator (not shown) of a flush valve 38 and via a wiring 40 to a coil 42 that operates a filling valve 46 by means of a plunger rod 44. Furthermore, collecting reservoir 2 of greywater device 1 is provided with a tap water supply 48.

Although greywater device 1 shown in the attached figure comprises collecting reservoir 2 and storage tank 4, it is apparent to a person skilled in the art that the concept of the invention described in this patent can be applied to every type of greywater device. In particular, it is noted that such a greywater device can comprise only one storage reservoir instead of one collecting reservoir 2 and one storage tank 4, and that the relationships shown in the figure between the volumes of collecting reservoir 2 and storage tank 4 are not reproduced to scale.

The greywater device shown in the figure, that makes use of a collecting reservoir 2, a storage tank 4 and a siphon connection 12 located between them has the particular advantage that the combination of these reservoirs can comprise a variable volume and create a compact and efficient greywater device such as described in Dutch patent NL-1030110 of the applicant.

The figure shows the greywater device in accordance with the present invention in a state of rest and with collecting reservoir 2 entirely filled with water. When the origin of this water is from a shower or a bath the water will be slightly contaminated with soap remnants, skin flakes and hairs, among other things. Relatively clean greywater can be siphoned to storage tank 4 for storage by making use of a collecting reservoir 2 and a storage tank 4 and attaching a siphon connection 12 between them that is connected to a mainly middle area of storage reservoir 2. Contaminants whose density is less than that of water, such as, e.g., soap remnants, will float in any case in storage reservoir 2 and contaminants with a density greater than that of water, such as, e.g., sand remnants, will sink in collecting reservoir 2. As a consequence thereof, the cleanest water is located mainly in the middle part, that is to say, between the bottom side and the top side of collecting reservoir 2.

Water stored in collecting reservoir 2 and in storage tank 4 is conducted via removal conduit 16 from greywater device 1 to cistern 20 of toilet 18, that is filled with greywater in order to be able to flush it with this water during the following use of the toilet.

The water supplied through supply conduit 14 for greywater can come from a number of sources including shower, bath, washbasin water, washing machine or rainwater. All these sources have their own characteristic contaminants and bacteria, as a result of which the greywater will develop undesired odors during a rather long standstill that can result in a odor nuisance. In order to prevent the formation of odor nuisance the water quality is determined and the water in reservoir 2 and in storage tank 4 of greywater device 1 and/or in cistern 20 of a toilet 18 connected to greywater device 1 is flushed respectively to sewer drain 24 of greywater device 1 and to sewer drain 22 of toilet 18 when the water quality drops below an acceptable level.

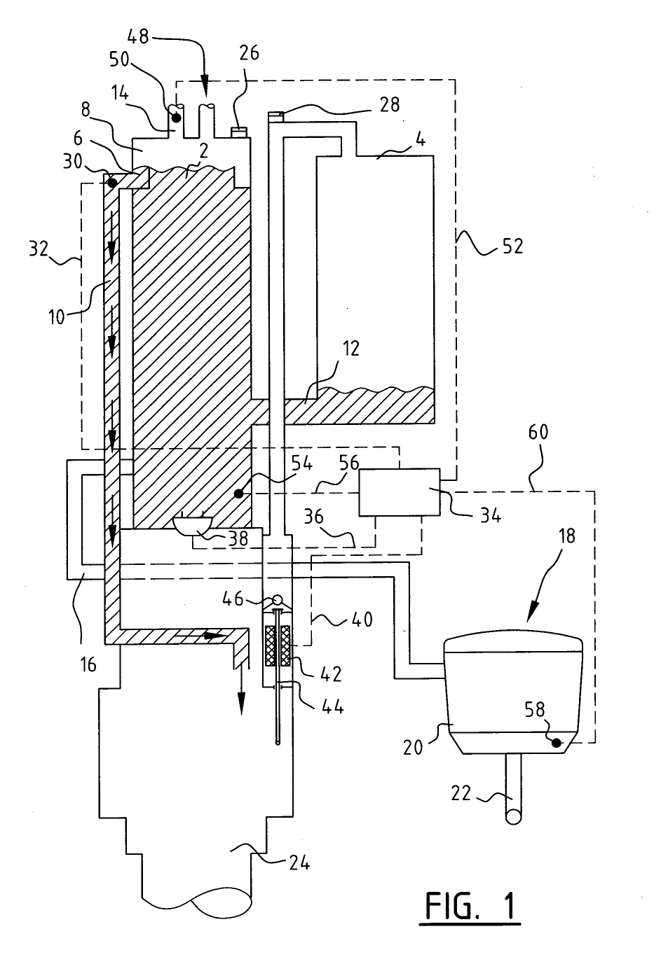

The greywater system comprises a control unit 34 that is also called an Ecoplay Control Unit (ECU). Control unit 34 communicates by wirings 32, 52, 56, 60 with various sensors 30, 50, 54, 58 in the system that provides control system 34 with information for determining the water quality. As can be seen in FIG. 1, these sensors can be located on several locations, such as in the reservoir of the greywater device, e.g. sensor 54 in collecting reservoir 2, or in a reservoir of a water consumer connected to the greywater device, e.g. sensor 58 in cistern 20 of toilet 18. Furthermore, the sensors can be located in a conduit, e.g. sensors 30 and 50 in respectively bypass conduit 10 and supply conduit 14.

In a preferred embodiment a sensor 54 is attached in collecting reservoir 2 and is connected with wiring 56 to control system 34. Sensor 54 measures, e.g., the temperature of the water present in the reservoir and can comprise a biosensor in addition that measures contaminants present in the water. Parameters that turned out to be an indicator in practice for the water quality are the electrical conductivity of the water, the concentration of hydrocarbons, the oxygen content of the water, the concentrations of urea and coliform elements, the iron content of the water and the acidity. In addition, the presence of byproducts produced as a consequence of contaminations, e.g. the presence of nitrite that can be produced from nitrate converted by bacteria, can indicate the presence of bacteria.

A sensor 50 is preferably attached in greywater supply conduit 14 which sensor is connected by wiring 52 to control system 34. Sensor 50 is set up to determine the origin of the water but it is also conceivable that the origin is communicated in a different manner to control system 34. In addition, sensor 50 can be set up to determine the temperature of the supplied water.

Control system 34 operates an actuator (not shown) of flush valve 38 as a function of the values measured by the sensors and the water quality determined by control system 34, as a result of which flush valve 38 is opened. At the same time control system 34 can open air vents 28 via a connection (not shown), after which the greywater present in collecting reservoir 2 and/or storage tank 4 disappears with the contaminants present in it via the opening in flush valve 38 via sewage drain 24 into the sewage.

In case of a power failure, e.g. to prevent the occurrence of legionella, the greywater present in the system will be flushed as the last action, after which it will be filled with tap water supplied via tap water supply 48 to collecting reservoir 2. Subsequently, tap water is supplied via tap water supply 48 when the available greywater is insufficient for providing the requirement of toilet 18.

In a further preferred embodiment purification additive is actively added as a function of the water quality.

Sensor 30 attached in bypass conduit 10 registers when collecting reservoir 2 is entirely filled and water flows at overflow 6 into bypass conduit 10. In the case that this situation shown in the figure occurs, control system 4 assumes that a sufficient amount of water is being supplied in order to assume that the concentration of contaminants is within acceptable limits. Alternative ways for determining the amount of supplied greywater is to measure the water level in reservoir 2 and tank 4, measure the amount of flowthrough in the supply conduit and the already shown registering of the occurrence of an overflow of reservoir 2 to bypass conduit 10. In that case that the supplied greywater comprises an amount that remains below a determined threshold value, this is registered by control unit 34 and the supplied greywater is flushed in the short term or even directly to sewer drain 24. Such a situation can occur, e.g., if someone takes a shower in a water-saving manner in which his body is briefly moistened and the shower is subsequently turned off and the person washes himself, followed by a brief rinsing off of the soap remnants. Due to the high concentration of contaminants to be expected in such a short use of the shower, this water should not be stored or only stored very briefly in the reservoir of the greywater device.

Greywater coming from such a short shower use, and also other greywater of which it is to be expected that it comprises a high concentration of contaminants, is preferably retained for a short time period before it is flushed. If the toilet is used in this short time period, this greywater—in spite of its high concentration of contaminants—can be used because the risk of odor development in such a short time is within acceptable limits.

However, it is also conceivable that a first person takes a shower very briefly, for which a high concentration of contaminants is plausible, whereas this brief use of the shower is followed within a foreseeable time by a longer use of the shower that dilutes the water supplied by the brief shower in such a manner that the water quality comes within acceptable limits.

According to a further preferred embodiment of the method, a minimal supply of water, e.g., measured by sensor 50, is ignored as a water supply, which prevents a brief supply of water resulting in an unnecessary flushing of the system due to a faulty estimation of an expected high concentration of contaminants. In order to make the system insensitive, among other things, to erroneous messages as a consequence of a leaky faucet or otherwise very slight supply of water, control system 34 defines a supply of water only as such when this supply lasts for a minimal time. This value can typically be adjusted at, e.g., 5 to 10 seconds. A construction of sensor 50 as a liquid flow meter or output meter forms alternative means for determining the amount of supply.

In a further preferred embodiment the time between two successive supplies of water to collecting reservoir 2 of greywater device 1 is measured. When two successive supplies of greywater take place within a time of a predetermined value, they are viewed by control system 34 as one single supply of greywater. When the time period between two successive supplies of greywater is above a predetermined time value, typically several hours, the greywater present in collecting reservoir 2 is then discharged via flush valve 38 to sewer drain 24, and collecting reservoir 2 is filled with new greywater. In this manner the greywater present in collecting reservoir 2 of greywater device 1 is held in a state that is as ‘young’ as possible, thereby applying the ‘keep the water young’ principle according to the present invention.

As already mentioned, contaminants with heavy parts present in greywater sink in collecting reservoir 2 and light parts floating on the water are conducted by skimmer 8 via bypass conduit 10 to sewer drain 24. Discharge conduit 16 for discharging greywater stored in storage reservoir 2 to a toilet is preferably connected at some distance from the bottom of collecting reservoir 2 to the latter, so that sunken contaminants are not transported via discharge conduit 16 to the toilet. If no flush to the sewerage has taken place for a rather long time already, sunken contaminants will accumulate on the bottom of collecting reservoir 2. By keeping count of the number of refill times and the passage of time since the flush to the sewer drain, control system 34 determines when it is desirable to flush the water present in collecting reservoir 2 in order to remove the sunken contaminants in collecting reservoir 2 to the sewerage.

In a preferred embodiment, reservoir 2 is filled with tap water after the flushing, or collecting reservoir 2 of greywater device 1 is purified by a purification unit (not shown). This purification unit squirts, e.g., tap water under high pressure against the walls of reservoir 2 and of storage tank 4. If desired, a disinfecting additive can be added.

In order to prevent that the system is flushed several times and is filled with tap water when it is not used for a rather long time, a previously determined maximal number of times of flushing after a refilling with tap water is specified in control system 34. After this previously determined maximal number of times of flushing, e.g., after two flushes, control system 34 will assume that the water stored in reservoir 2 of greywater device 1 and in storage tank 4 is so clean that the chance of a odor nuisance is below an acceptable level and that flushing is no longer necessary.

The embodiments described above are, although they concern preferred embodiments of the invention, simply intended to illustrate the present invention and not to limit in any manner the description of the invention. In particular, it is noted that although the exemplary embodiment illustrated in the description of the figure only shows one water consumer in the form of a toilet, several water consumers can also be connected to the system. The requested rights are determined by the following claims within the scope of which many modifications are conceivable.

1. Method for the processing of greywater, comprising the steps of:
supplying water to a reservoir of a greywater device;
collecting the supplied water in the reservoir;
conducting water out of the reservoir to at least one reservoir of a water consumer;
monitoring the water quality; and
flushing the water from the reservoir of the greywater device and/or from the reservoir of the water consumer into a sewer drain when the water quality drops below an acceptable level.

2. Method according to claim 1, in which the step of monitoring the water quality comprises frequently and satisfactorily determining at least one of the properties determining the water quality.

3. Method according to claim 1 or 2, further comprising the following steps:
assigning a water quality value to the collected water; and
adapting the water quality value as a function of at least one parameter that influences the water quality.

4. Method according to any of the foregoing claims, further comprising the step of adapting the water quality as a function of at least one of the following parameters:
temperature of the supplied water;
temperature of an environment of the reservoir of the greywater device;
temperature of an environment of the reservoir of the water consumer;
origin of the supplied water;
contaminants present in the water;
additives present in the water;
the amount of the supplied water; and
in which reservoir the water is located.

5. Method according to claim 4, in which the origin of the supplied water is at least one of the following sources: shower, bath, dish-washer, washing machine or rainwater.

6. Method according to claim 4 or 5, further comprising the step of detecting contaminants present in the water by at least one of the following:
measuring an electrical conductivity of the water;
measuring the concentration of hydrocarbons;
measuring the concentration of oxygen;
measuring the concentration of urea;
measuring the concentration of coliform elements;
measuring the iron content in the water;
measuring the acidity of the water;
measuring with the aid of biosensors; and
measuring the presence of byproducts produced as a consequence of contaminants.

7. Method according to any of the foregoing claims, further comprising the step of actively adding a purification additive as a function of the water quality.

8. Method according to any of the foregoing claims, in which the acceptable level of the water quality that serves as the lower limit for determining whether water should be flushed into the sewer drain, is a function of the type of reservoir in which the water is located.

9. Method according to any of the foregoing claims, further comprising the step of determining with a sensor the amount of supplied water, the sensor monitoring at least one of the following parameters: water level, amount of flowthrough, overflow of water into the reservoir of the greywater device, and flowthrough of water into a bypass conduit of the greywater device.

10. Method according to any of the foregoing claims, further comprising the step of flushing water collected in the reservoir of the greywater device when the amount of the supplied water remains below a determined threshold value.

11. Method according to claim 10, further comprising the step of flushing the water collected in the reservoir of the greywater device after a determined time.

12. Method according to claim 10, further comprising the step of preventing the flushing of the water in the reservoir of the greywater device when water is used by a water consumer before the passage of the time period.

13. Method according to any of the foregoing claims, further comprising ignoring as water supply a supply of water in an amount less than a predetermined value.

14. Method according to any of the foregoing claims, further comprising the following steps:
measuring the time interval between successive supplies of water to the reservoir of the greywater device;
defining successive supplies as one single supply of water when they occur within a predetermined time interval; and
defining subsequent supplies as a separate first and following supply when they occur outside a predetermined time interval, and further comprising flushing the water of the first supply out of the reservoir and filling the reservoir with the water from the following supply.

15. Method according to any of the foregoing claims, further comprising keeping track of the number of refill times since the flushing to the sewer drain, and the flushing of the water collected in the reservoir when a predetermined number of refill times is reached since the last flush.

16. Method according to any of the foregoing claims, further comprising keeping track of the time interval since a flush to the sewer drain and the flushing of the water collected in the reservoir when a predetermined time interval has passed since the last flush.

17. Method according to claim 15 or 16, further comprising filling the reservoir with tap water after a flush.

18. Method according to claim 17, further comprising the flushing of the reservoir filled with tap water to the sewer drain a predetermined maximum number of times.

19. Method according to any of claims 1-15, further comprising the purifying of the reservoir of the greywater device with a purifying device.

20. Control system for controlling a greywater device, comprising:
at least one sensor connected to the control system, for measuring a water quality of water collected in a reservoir of the greywater device and/or collected in a reservoir of a water consumer connected to the greywater device; and
flushing the water out of the reservoir of the greywater device and/or out of the reservoir of the water consumer connected to the greywater device, when the water quality drops below an acceptable level as a function of the measured water quality.

21. Control system according to claim 20, in which the method is used in accordance with one or more of claims 1-19.

22. System for reusing greywater, comprising of a greywater device and a control system, said greywater device comprising:
a water supply for supplying greywater;
a reservoir for collecting the supplied greywater;
a conduit connected to a water consumer;
a sewer drain; and
a control system, comprising:
at least one sensor connected to the control system, for measuring a water quality of water collected in a reservoir of the greywater device and/or collected in a reservoir of a water consumer connected to the greywater device; and
flushing the water out of the reservoir of the greywater device and/or out of the reservoir of the water consumer connected to the greywater device, when the water quality drops below an acceptable level as a function of the measured water quality.

23. The system according to claim 22, in which the method is used in accordance with one or more of claims 1-19.

24. Greywater consumer, especially a toilet, comprising:
a first conduit connected to a reservoir of a greywater device;
a second conduit connected to a water supply system;
a water reservoir for storing water;
a sewage drain; and
an actuator for flushing water stored in the water reservoir to the sewage drain, the actuator being controlled by a control system, comprising:
at least one sensor connected to the control system, for measuring a water quality of water collected in a reservoir of the greywater device and/or collected in a reservoir of a water consumer connected to the greywater device; and
flushing the water out of the reservoir of the greywater device and/or out of the reservoir of the water consumer connected to the greywater device, when the water quality drops below an acceptable level as a function of the measured water quality.

25. Greywater consumer according to claim 24, in which the method according to any of claims 1-19 is used.
